(19) United States
(12) Patent Application Publication
(10) Pub. No.: US 2007/0031293 A1
(43) Pub. Date: Feb. 8, 2007

(54) Method and apparatus for collecting and diluting a liquid sample

(76) Inventor: Christopher C. Beatty, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/197,960

(22) Filed: Aug. 4, 2005

(51) Int. Cl. B01L 3/02

(52) U.S. Cl. 422/100

(57) ABSTRACT

An instrument for collecting a fluid sample includes a collector for collecting the fluid sample using capillary forces, and a reservoir of diluent incorporated into the instrument for diluting the fluid sample. A method of collecting a fluid sample includes collecting the fluid sample with an instrument using capillary forces; and diluting the fluid sample in the instrument with a reservoir of diluent incorporated into the instrument.

### BACKGROUND

Small blood samples are often collected after a lancet or other sharp instrument has been used to make a small incision from which blood emerges. Once collected, these samples can be analyzed for a wide variety of purposes. The analysis and quantification of blood components is an important diagnostic tool for better understanding the physical condition of a patient.

This method of making an incision to extract a blood sample is clearly invasive and painful for the person from whom the sample is being taken. Unfortunately, adequate noninvasive blood analysis technology is not currently available. Consequently, blood samples still need to be obtained by the invasive method of making an incision to extract blood for the sample.

A great number of patients need to take and analyze a blood sample on a frequent, even daily, basis. A well known example is the self monitoring of glucose levels by a diabetic individual. Many products for self-monitoring of blood glucose levels are available commercially. Upon doctors' recommendations and using such products, patients typically measure blood glucose level several times a day as a way to monitor their success in controlling blood sugar levels. For many diabetics, the failure to test blood glucose regularly may result in damage to tissues and organs, such as kidney failure, blindness, hypertension, and other serious complications. Other patients that may need to test their blood regularly include advanced renal disease patients and heart failure patients.

Nevertheless, many patients do not test their blood regularly for the simple reason that existing monitoring products may be complicated, inconvenient, and painful. Furthermore, these products require some skill, dexterity, and discipline to obtain useful measurements.

### SUMMARY

An instrument for collecting a fluid sample includes a collector for collecting the fluid sample using capillary forces, and a reservoir of diluent incorporated into the instrument for diluting the fluid sample. A method of collecting a fluid sample includes collecting the fluid sample with an instrument using capillary forces; and diluting the fluid sample in the instrument with a reservoir of diluent incorporated into the instrument.

### BRIEF DESCRIPTION OF THE DRAWINGS

The accompanying drawings illustrate various embodiments of the present invention and are a part of the specification. The illustrated embodiments are merely examples of the present invention and do not limit the scope of the claims.

FIG. 1 is an illustration of a conventional system for taking and diluting a blood sample.

FIG. 2 is an illustration of one example of an instrument according to principles described herein for collecting and diluting a fluid sample, such as a blood sample.

FIG. 3 is another illustration of the exemplary instrument described herein including a filter for filtering the fluid sample as it is delivered to analysis equipment.

FIG. 4 is another illustration of the exemplary instrument described herein including a plunger for applying pressure to deliver the collected sample to analysis equipment.

FIG. 5 is a flow chart illustrating an exemplary method of operating the instrument described herein.

Throughout the drawings, identical reference numbers designate similar, but not necessarily identical, elements.

### DETAILED DESCRIPTION

The present specification describes an instrument or device and method for taking a fluid sample, such as a blood sample, in which a known quantity of a diluting agent or reagent is added to a known quantity of sample with and within the same instrument used to collect the sample. As will be explained in detail below, this allows a sample to be much more readily collected and prepared for subsequent analysis without requiring as much manual dexterity or equipment as did prior systems.

Small samples of whole blood, blood components, other bodily fluids and other fluids generally, e.g. 10 microliters or less, are very difficult to manage due to clotting, evaporation and, in microfluidic systems, pinning by capillary forces. Taking a larger sample ameliorates these difficulties. However, taking a larger sample is obviously disadvantageous, particularly, as in the example of a diabetic patient, where blood samples must be taken relatively frequently.

Consequently, it is common practice to mix the small blood sample or other sample with a known quantity of a liquid diluting agent or reagent. By mixing the sample into a diluting agent or reagent, the problems with clotting, evaporation and pinning are greatly reduced or even eliminated. As used herein and in the appended claims, the term “diluent” will be used broadly to refer to any agent with which a sample of blood or other fluid is mixed to prepare the sample for subsequent analysis.

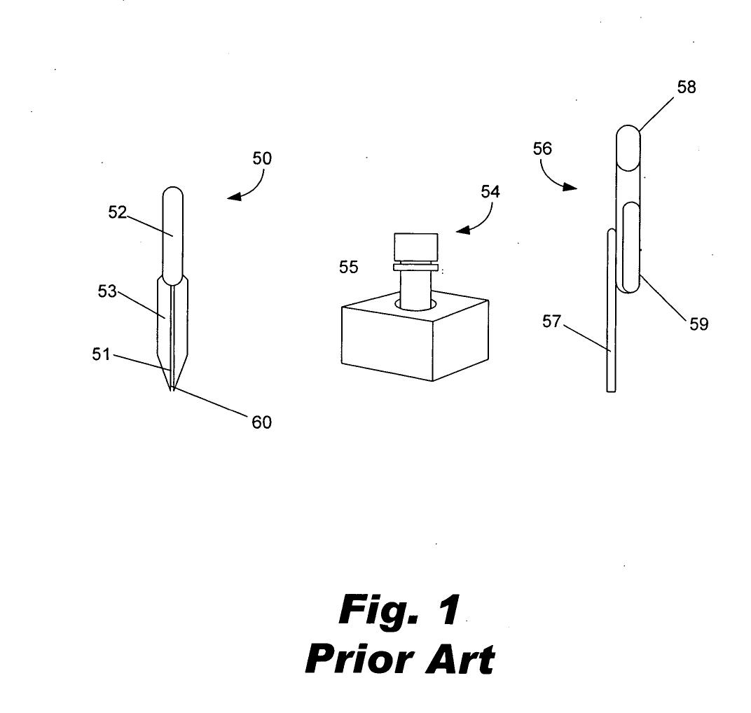

In previous systems, a blood sample has typically been collected with one instrument and then expelled from that collection instrument into a quantity of diluent in a different container. An example of such a system is illustrated in FIG. 1.

As shown in FIG. 1, a capillary instrument (50) is used to collect a small sample of blood. As described above, an incision is made, typically in a patient's finger, and the desired blood sample is then collected. The finger is the preferred place for routine sampling simply because it is so readily accessible.

The incision is made with a lancet or lancing device. The lancing device can take many forms from a simple needle to a spring-loaded lancing device with replaceable lancets. Any device for making an incision and drawing a blood sample may be used.

Assuming a spring-loaded lancing device, the process of taking a blood sample with the system illustrated in FIG. 1 will now be described. First, the patient, or a medical practitioner taking the sample, cleans the patient's finger. The one taking the sample then prepares the lancing device by (1) removing a cover, (2) placing a disposable lancet in the lancing device, (3) removing a protective shield from the sharp lancet tip, (4) replacing the cover, and (5) setting a spring-like mechanism in the lancing device which provides the force to drive the lancet into the skin. Some or all of these steps may happen simultaneously, e.g., some lancing devices set their spring mechanisms automatically when one installs the lancet.

The one taking the sample then places the lancing device on the finger. The density of nerve endings decreases toward the lateral edges of the fingertips. Consequently, slightly lateral locations are preferred to the fingertips for making an incision. After positioning the lancing device on the finger, the one taking the sample presses a button or switch on the device to release the lancet. The spring drives the lancet forward, creating a small wound.

After lancing, a small droplet of blood may appear spontaneously at the lancing site. This droplet is usually 2-20 microliters in volume. If no blood sample appears spontaneously, the patient may “milk” the finger by massaging or squeezing it slightly, thereby promoting blood flow from the wound. In either case, the one taking the sample must examine the droplet of blood and judge by eye and experience whether the size of the droplet will provide an adequate blood sample. If the amount is inadequate, the one taking the sample may continue to massage the finger or lancing site until a sufficient quantity of blood has emerged.

At this point, the one taking the sample will employ the capillary instrument (50) shown in FIG. 1. The tip (60) of the instrument (50) is brought into contact with the droplet of blood that has been extracted from the lancing. A capillary (51) that extends into the body of the instrument (50) is open at the tip (60) of the instrument (50). Once the tip (60) is brought into contact with the blood droplet, capillary forces draw blood into the capillary (51) thereby collecting the desired blood sample.

A visible mark, such as a line or other indicator, may be drawn or otherwise formed on the instrument (50) along the capillary (53). This mark will indicate how much of the capillary (51) must be filled with blood for the sample to be adequate for subsequent analysis.

Next, the sample is expelled from the instrument (50) into a diluent (55). The diluent (55) is contained in a separate tube or vial (54). The tip (60) of the capillary instrument (50) is inserted into the top of the tube (54). A bulb (52) provided at the top of the instrument (50) can be squeezed or pumped to force the blood sample out of the capillary (51) and into the diluent (55) in the tube (54).

This process of expelling the sample into the tube (54) requires some dexterity. One must remove the cap from the tube (54) and, without spilling diluent (55), insert the instrument (50) into the tube (54) and expel the sample into the diluent (55). While not difficult for some, this process may be difficult for disabled or elderly patients, some of whom may need to self-sample their blood for analysis on a frequent basis.

After the sample is diluted in the diluent (55) a transfer pipette (56) is used to transfer the diluted sample to analysis equipment. The user compresses a squeeze bulb (58) and then inserts a barrel (57) of the pipette (56) into the diluted sample. Releasing the squeeze bulb (58) and allowing it to expand naturally draws a quantity of the diluted sample through the hollow barrel (57) and into a reservoir (59) of the pipette.

The barrel (57) can then be positioned to deposit the sample into appropriate analysis equipment. The squeeze bulb (58) is again compressed to expel the diluted sample from the reservoir (59) through the barrel (57) and into or onto the analysis equipment. In the example of a diabetic patient, the sample may be expelled from the transfer pipette (56) to the sample well of an electronic glucose meter. Again, this process of using the transfer pipette to draw transfer fluid from the tube (54) to analysis equipment requires some dexterity that may be difficult for some users.

As an alternative to this system, other systems have been developed in which the undiluted sample is expelled onto a test disc that includes a quantity of aqueous diluent in the center and dry reagent beads in cuvettes around the disc periphery. Mixing of the sample with the diluent and reagent is then controlled by centrifugal forces, as the disk is spun, and by capillary forces. Plasma separation and volumetric measurements can also be performed with the disk.

The entire disk is inserted into a specialized analysis device to conduct the mixing and the desired analysis on the resulting diluted sample. This system, however, adds complexity and expense due to both the test disk and the specialized analysis equipment needed to support the test disks. Additionally, many of the problems associated with a small sample, i.e., clotting, evaporation and pinning, may still occur before or as the sample is provided to the test disk and subsequently diluted.

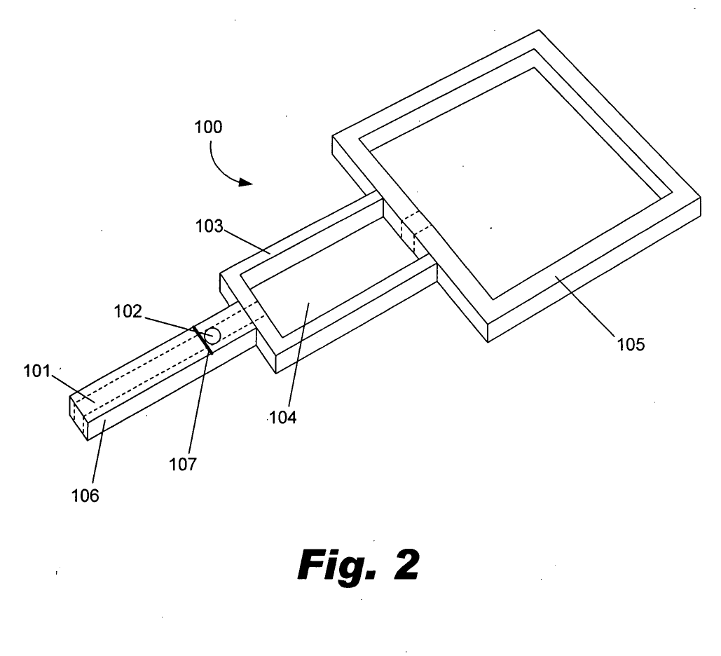

FIG. 2 illustrates a novel capillary instrument (100) for both collecting a fluid sample, such as a blood sample, and mixing that sample with a quantity of diluent. As shown in FIG. 2, the instrument (100) includes a collector (106) which includes a capillary (101). The diameter of the capillary (101) may be about 1 mm, for example.

When the open end of the capillary (101), at the tip of the collector (106), is brought into contact with a quantity of liquid, for example blood, a sample of that liquid is drawn into the capillary (101) by capillary forces. In this way, the desired sample of that liquid is collected.

Liquid will continue to be drawn into the capillary (101) until it reaches a break feature (102). The break feature (102) disrupts the capillary forces operating in the capillary (101) so that liquid is not drawn further into the capillary (101). The break feature (102) may be, for example, a widening of the capillary (101) to a point beyond which the capillary forces will operate. Alternatively, the break feature (102) may be a small hole in the collector (106) that disrupts the operation of the capillary forces. The hole may be covered by a gas-permeable membrane to prevent any liquid leakage from the instrument. Any other means of disrupting the capillary forces may be used as the break feature (102).

The collector (106) is typically formed of transparent material such that a user can see the sample being drawn into the capillary (106) up to the break feature (102). The break feature (102) may also be associated with a visible line (107) or other visible indicator disposed on the collector (106) so that a user can readily see where the break feature (102) is and how much of the capillary (101) should be filled when collecting a sample. Thus, the break feature (102) can be positioned along the capillary (101) specifically to indicate the volume of sample that should be collected in the capillary (101) based on the amount needed for subsequent analysis.

The instrument (100) also includes a diluent reservoir (103) that is filled with a specific and known quantity of diluent (104). This reservoir (103) is in fluid communication with the capillary (101) of the collector (106), perhaps with a valve, breakable membrane or other means to prevent diluent (104) from entering the capillary (101) unless under a minimal amount of pressure, as will be described in more detail below.

The instrument (100) also includes a chamber (105), in fluid communication with the diluent reservoir (103), that is used to expel the sample and diluent (104) from the instrument (100). In the example illustrated in FIG. 2, the chamber (105) is a squeeze chamber or squeeze bulb that is flexible and initially filled with a quantity of air or other gas or fluid.

After a sample has been drawn into the capillary (101) of the collector (106), the tip of the collector (106) with the open end of the capillary (101) can be positioned over analysis equipment that is ready to receive and analyze a diluted sample, for example, the sample well of a chemical analyzer, a test card or strip, etc.

The user then compresses the squeeze chamber (105), expelling air or other fluid under pressure from the chamber (105). This action applies pressure to the diluent (104) in the reservoir (103), the chamber (105) being in fluid communication with the diluent reservoir (103).

The diluent (104) is thus forced into and through the capillary (101). As the diluent (104) is forced through the capillary (101), the diluent (104) flushes the sample from the capillary (101) while also automatically mixing with and diluting the sample. As a result, a properly diluted sample is expelled from the instrument (100) ready for use by the corresponding analysis equipment.

Consequently, the illustrated instrument (100) allows for the easy collection of a small sample of blood or other fluid and the mixing of that sample with an appropriate and known quantity of diluent preparatory to analysis of the sample. The user of the instrument (100) need not use the diluent mixing tube, transfer pipette, diluent-bearing test disk or other additional equipment required by the previous systems described herein. Moreover, the instrument (100) and its method of use require significantly less manual dexterity than do the alternative systems described above.

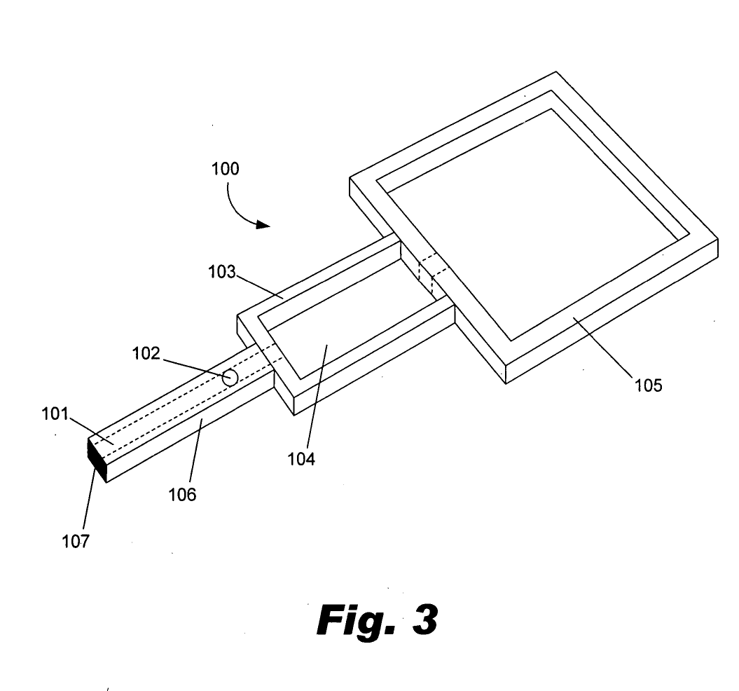

FIG. 3 illustrates another possible feature of the instrument (100). As shown in FIG. 3, after the sample has been drawn into the collector (106), a filter (107) may be disposed over the tip of the collector (106) and over the open end of the capillary (101). This filter (107) is designed to pass only the diluent (104) and one or more components of the sample in the capillary that are desired for analysis.

For example, the sample in the collector (106) may be whole blood. If an analysis of blood plasma is desired, rather than whole blood, an appropriate filter (107) will be disposed over the tip of the collector (106). This filter (107) will pass only diluent and plasma when the chamber (105) is compressed. Other blood components are retained in the collector (106). As a result, the instrument (100) easily and readily provides a sample of diluted blood plasma for analysis, rather than a sampling of whole blood.

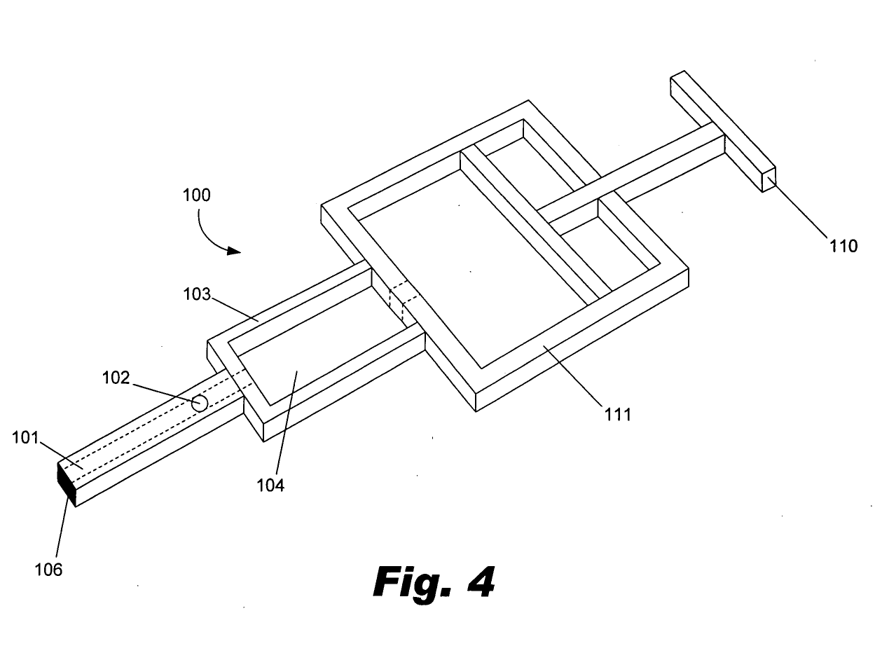

FIG. 4 illustrated another possible feature of the instrument (100). In this example, the chamber of the instrument used to expel the diluent (104) need not be a flexible container or a squeeze bulb. Rather, as shown in FIG. 4, the chamber (111) may incorporate a plunger (110). Pressure is applied to the plunger (110) to decrease the internal volume of the air or other fluid in the chamber (111). Thereby causing the expulsion, under pressure, of the diluent (104) from the reservoir (103) through the capillary (101) of the collector (106).

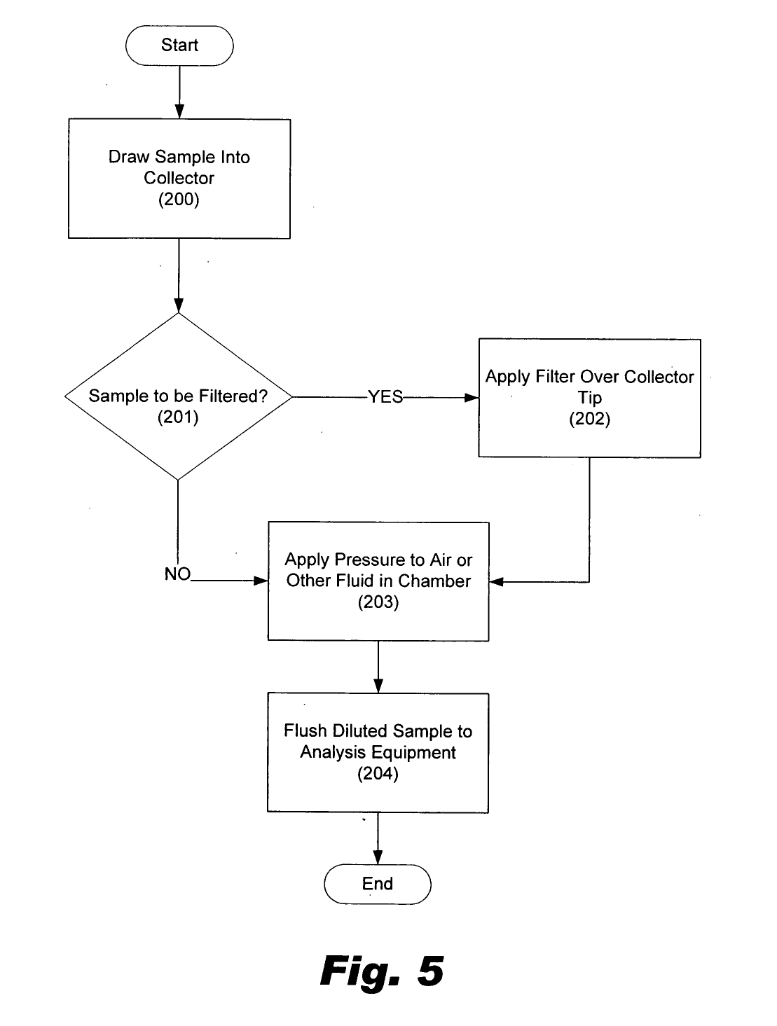

FIG. 5 is a flow chart illustrating an exemplary method of operating the instrument described herein. As shown in FIG. 5, sample of fluid is drawn into the instrument's collector by capillary forces (step 200). This is done by bringing the tip of the instrument, including an open capillary, into contact with the fluid to be sampled.

Once the sample is collected into the instrument, it may be desired to filter the sample so that only a particular component or components of the sample are later expelled for analysis. If filtration is desired (determination 201), an appropriate filter is applied over the tip of the collector containing the sample (step 202). If filtration is not desired, no filter need be applied.

Next, pressure is applied to the instrument's chamber (step 203) to dilute the sample and expel the diluted sample to analysis equipment. As described above, applying pressure to the chamber may, for example, involve compressing a flexible chamber or operating a plunger disposed within the chamber.

As a result, diluent is forced into the collector where it mixes with and flushes the sample from the instrument to appropriate analysis equipment (step 204). As a result, a properly diluted sampled is expelled to the analysis equipment using only the single instrument described, without the need for additional equipment or significant dexterity in handling such equipment.

The preceding description has been presented only to illustrate and describe embodiments of the invention. It is not intended to be exhaustive or to limit the invention to any precise form disclosed. Many modifications and variations are possible in light of the above teaching.

What is claimed is:

1. An instrument for collecting a fluid sample comprising:
a collector for collecting said fluid sample using capillary forces; and
a reservoir of diluent incorporated into said instrument for diluting said fluid sample.

2. The instrument of claim 1, wherein said reservoir of diluent is fluid communication with said collector so as to mix diluent with said sample when said sample is expelled from said instrument.

3. The instrument of claim 2, further comprising a chamber to which pressure is applied, said chamber being in fluid communication with said diluent reservoir so as to force diluent into and through said collector when said pressure is applied.

4. The instrument of claim 3, wherein said chamber is a flexible squeeze chamber and said pressure is applied by compressing said flexible squeeze chamber.

5. The instrument of claim 3, wherein said chamber comprises a plunger and said pressure is applied through movement of said plunger.

6. The instrument of claim 1, further comprising a break feature disposed along a capillary of said collector, said break feature disrupting said capillary forces.

7. The instrument of claim 6, wherein said break feature is located at a point along said capillary corresponding to a specific desired sample quantity.

8. The instrument of claim 6, wherein said break feature comprises a widening of said capillary.

9. The instrument of claim 6, wherein said break feature comprises a hole in said collector.

10. The instrument of claim 9, wherein said hole is covered with a gas-permeable membrane.

11. The instrument of claim 1, further comprising a filter removeably disposed on said collector so as to filter said fluid sample when said sample is expelled from said instrument.

12. The instrument of claim 10, wherein said filter filters plasma from whole blood.

13. A method of collecting a fluid sample, said method comprising:
collecting said fluid sample with an instrument using capillary forces; and
diluting said fluid sample in said instrument with a reservoir of diluent incorporated into said instrument.

14. The method of claim 13, wherein said fluid sample is blood.

15. The method of claim 13, further comprising flushing said fluid sample from a collector using diluent from said reservoir such that said sample is diluted with said diluent.

16. The method of claim 15, further comprising expelling said diluted sample from said instrument to analysis equipment.

17. The method of claim 13, further comprising applying pressure with a chamber in fluid communication with said diluent reservoir so as to force diluent into and through a collector containing said sample.

18. The method of claim 17, wherein said chamber is a flexible squeeze chamber, and said method further comprises compressing said flexible squeeze chamber.

19. The method of claim 17, wherein said chamber comprises a plunger, and said method further comprises pressing said plunger to apply said pressure.

20. The method of claim 13, further comprising collecting said sample so as to fill a capillary of said instrument up to a break feature disposed along said capillary, said break feature disrupting said capillary forces.

21. The method of claim 20, wherein said break feature is located at a point along said capillary corresponding to a specific desired sample quantity.

22. The method of claim 20, wherein said break feature comprises a widening of said capillary.

23. The method of claim 20, wherein said break feature comprises a hole in said collector.

24. The method of claim 13, further comprising filtering said fluid sample when said sample is expelled from said instrument.

25. The method of claim 24, wherein said filtering comprises filtering plasma from whole blood.

26. A method of making an instrument for collecting a fluid sample comprising:
forming a collector comprising a capillary for collecting said fluid sample using capillary forces; and
forming a reservoir of diluent incorporated into said instrument for diluting said fluid sample.

27. The method of claim 26, further comprising forming a chamber, in connection with said reservoir, to which chamber pressure can be applied so as to force diluent into and through said collector.

28. The method of claim 26, further comprising forming a break feature along said capillary of said collector, said break future disrupting said capillary forces.

29. The method of claim 28, wherein said break feature is located at a point along said capillary corresponding to a specific desired sample quantity.

30. The method of claim 26, further comprising providing a filter configured to be removeably disposed on said collector so as to filter said fluid sample when said sample is expelled from said instrument.

31. An instrument for collecting a fluid sample, comprising:
a collector adapted to collect said fluid sample using capillary forces; and
a reservoir in fluid communication with said collector, said reservoir adapted to hold a pre-selected volume of a diluent, wherein expulsion of said diluent from said instrument mixes said diluent and said fluid sample.

32. An instrument for collecting a fluid sample, comprising:
a capillary collector tube having a capillary break disposed along said tube, said capillary collector tube disrupting capillary forces in said tube and adapted to collect said fluid sample; and
a reservoir in fluid communication with said capillary collector tube, said reservoir adapted to hold a pre-selected volume of a diluent; and
a chamber to which pressure is applied, said chamber being in fluid communication with said reservoir, wherein application of pressure to said chamber forces said diluent into and through said capillary collector tube mixing said diluent and said fluid sample.
